(19) United States
(12) Patent Application Publication
(10) Pub. No.: US 2026/0359303 A1
(43) Pub. Date: Nov. 12, 2026

(54) LONG TERM MEMORY ENHANCEMENT

(71) Applicant: Samsung Electronics Co., Ltd., Suwon-si (KR)

(72) Inventors: Zhongyang Zhang, San Diego, CA (US); Yu Zhang, Frisco, TX (US); Hao Chen, Allen, TX (US); Han Wang, Allen, TX (US); Priyabrata Parida, Dallas, TX (US)

(21) Appl. No.: 19/668,741

(22) Filed: May 5, 2026

Related U.S. Application Data
(60) Provisional application No. 63/801,667, filed on May 7, 2025.

(51) Int. Cl. G06F 16/2457; G06F 16/25; G06F 40/174; G06F 40/279; G06F 40/30; G06V 20/20; G06V 20/40; G10L 15/01

(52) U.S. Cl. CPC G06F 16/2457; G06F 16/258; G06F 40/174; G06F 40/279; G06F 40/30; G06V 20/20; G06V 20/41; G06V 20/46; G10L 15/01

(57) ABSTRACT

A method includes receiving, by a first electronic device, unstructured sensor data associated with a user environment from one or more sensors. The method further includes transforming, by the first electronic device, the unstructured sensor data into structured text-based data using a vision language model (VLM) and a large language model (LLM). The method also includes storing, by the first electronic device, the structured text-based data using a spatial-temporal knowledge graph (STKG).

### CROSS-REFERENCE TO RELATED APPLICATION AND CLAIM OF PRIORITY

The present application claims priority under 35 U.S.C. § 119(e) to U.S. Provisional Patent Application No. 63/801,667 filed on May 7, 2025, which is hereby incorporated by reference in its entirety.

### TECHNICAL FIELD

This disclosure relates generally to wireless networks. More specifically, this disclosure relates to an apparatus and method of long term memory enhancement for wearable devices.

### BACKGROUND

As demand surges for immersive and personalized experiences in augmented and virtual reality (AR/VR), enhanced memory capabilities are becoming essential to seamlessly integrate and recall relevant information. Current wearable technology may lack robust mechanisms to effectively manage and recall context-specific data, leading to fragmented experiences and cognitive overload. Moreover, efficiently storing and accurately retrieving information accumulated over extended periods, such as an entire lifetime, may pose substantial challenges.

### SUMMARY

This disclosure provides apparatuses and methods of long term memory enhancement for wearable devices.

In one embodiment, a method may include receiving, by a first electronic device, unstructured sensor data associated with a user environment from one or more sensors. The method further includes transforming, by the first electronic device, the unstructured sensor data into structured text-based data using a vision language model (VLM) and a large language model (LLM). The method also include storing, by the first electronic device, the structured text-based data using a spatial-temporal knowledge graph (STKG).

In another embodiment, a first electronic device is provided. The first electronic device may include a memory and a processor operably coupled to the memory. The processor may be configured to receive unstructured sensor data associated with a user environment from one or more sensors, transform the unstructured sensor data into structured text-based data using a VLM and an LLM, and store the structured text-based data using a STKG.

In yet another embodiment, a non-transitory computer readable medium embodying a computer program is provided. The computer program may include program code that, when executed by a processor of a first electronic device, causes the first electronic device to: receive unstructured sensor data associated with a user environment from one or more sensors, transform the unstructured sensor data into structured text-based data using a VLM and an LLM, and store the structured text-based data using an STKG.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example network configuration including an electronic device in accordance with example embodiments of the present disclosure;

FIG. 2 illustrates an example episodic data production technique in accordance with example embodiments of the present disclosure;

FIG. 3 illustrates an example spatial-temporal knowledge graph (STKG) architecture in accordance with example embodiments of the present disclosure;

FIG. 4 illustrates an example dynamic STKG update mechanism in accordance with example embodiments of the present disclosure;

FIG. 5 illustrates an example STKG-based memory system in accordance with example embodiments of the present disclosure;

FIG. 6 illustrates an example STKG-based memory system in accordance with example embodiments of the present disclosure; and

FIG. 7 illustrates a flow chart of an example STKG-based memory enhancement method in accordance with example embodiments of the present disclosure.

### DETAILED DESCRIPTION

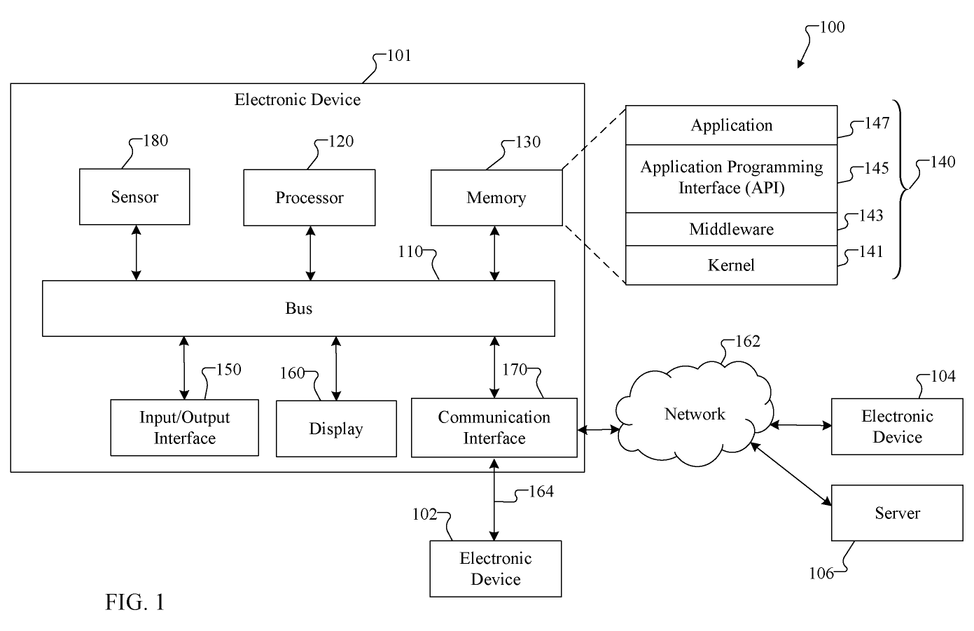

FIGS. 1 through 7, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

Efficient memory construction for power- and compute-constrained wearable devices may present a significant challenge, particularly when addressing the continuous influx of new events streamed into sensors over extended periods, such as a lifelong span. In addition, users may pose queries in unpredictable ways, ranging from event counting and past discussion retrieval to person recognition, resulting in a highly optimized system design encompassing key components such as event detection, frame selection, information embedding, and data representation. Further, some memory technologies may lack robust mechanism for effectively managing and retrieving context-specific data. This may result in fragmented user experiences, cognitive overload, and other limitations such as difficulty sustaining memory over extended periods, high storge footprint, significant computational complexity, and low quality retrieval that may lead to misunderstanding and incorrect responses.

This disclosure addresses goals for a memory enhancement system designed specifically for wearables like VR glasses, aiming to provide users with an intuitive and efficient method to store, access, and retrieve information, thereby fostering deeper engagement, improved learning, and ultimately, more enriching and productive interaction within the digital world.

This disclosure may resolve the memory issues by providing an enhanced memory method and system including: (i) a sensing pipeline designed to minimize end-device wake-up time and reduce data streaming overload, (ii) powerful large multimodal language models (LMLMs), both online and offline versions, utilized to extract meaningful information from the sensed data, (iii) a spatial-temporal knowledge graph (STKG) memory representation method developed to efficiently store the extracted information, enabling fast and accurate retrieval, and (iv) various optimizations implemented to transform the system into a production-ready prototype platform. As such, the key features of the enhanced memory method and system may include synchronized video and audio streaming design and conversion to textual content, effective information extraction with large models, STKG construction and update methods, creation of event history time as node/edge attributes for event counting and temporal reasoning, and comprehensive and fully optimized end-to-end memory aid system design.

This enhanced memory system may be optimized for time-related queries by creating a unique occurrence history time and node/edge-reidentification and content-merging mechanism. For example, a deeply optimized design may synergistically combine emerging technologies such as multi-sensor data fusion, LMLMs, and STKGs to construct a cohesive and dynamically adaptable memory system. By selecting the STKG as the primary data structure for memory storage, the present disclosure may utilize the highly efficient information representation and structured organization of the STKG. For example, the hierarchical node and edge structures of the STKG may facilitate bottom-up memory creation, enabling grounded memory formation, while also supporting top-to-bottom searches that enhance retrieval accuracy and speed. Additionally, the rich information stored in node and edge attributes may empower a wide range of previously challenging tasks, including event counting, temporal reasoning, and semantic reasoning.

By utilizing large VLMs and LLMs, the enhanced memory method and system may transform unstructured streaming data (e.g., video, audio) into structured text-based relational tuples based on extracting node details and node interactions for improving context. By using an STKG as a data structure, the enhanced memory method and system may store and organize the captured information, including node merging and edge merging that remove duplicate nodes and duplicate edges and preserve details while controlling graph complexity. By adding an event history timestamp for a node or an edge, the enhanced memory method and system may provide the history of respective node attribute or respective edge attribute, not merely the present attributes. For example, the event history timestamps may indicate when nodes (e.g., representing specific objects) or edges (e.g., representing actions) appear from a raw source (e.g., video and audio).

Leveraging these optimization technologies, the enhanced memory system may create a personalized and context-aware memory support, enabling seamless recall and integration of information within the user's AR/VR experience. It may also unlock the potential for the wearables to become invaluable tools for education, training, productivity, and personalized assistance by seamlessly integrating memory support into the daily life of users.

The example embodiments of the STKG-based enhanced memory system and method and other relevant features in accordance with the present disclosure are illustrated in FIGS. 1-7.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to communication methods among wearable devices.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, support communication methods among wearable devices in accordance with the present disclosure. These functions can be performed by a single application or by multiple applications that each carries out one or more of these functions. The middleware 143 can function as a relay to allow the API 145 or the application 147 to communicate data with the kernel 141, for instance. The middleware 143 may also include, for example, a spatial-temporal knowledge graph (STKG) as a data structure for storing and organizing captured information. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture image frames of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. The server 106 may perform one or more functions related to communication methods among wearable devices.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

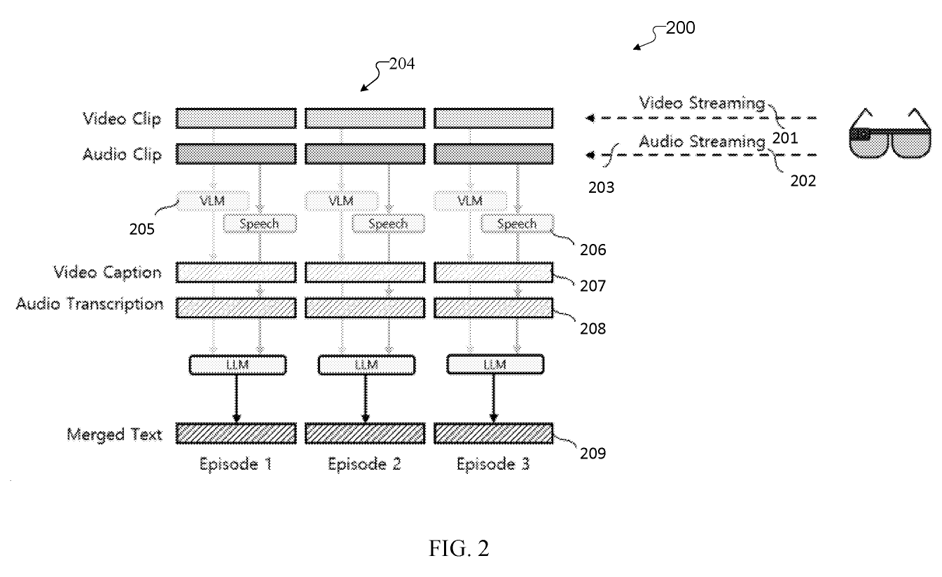

FIG. 2 illustrates an example episodic data production technique 200 in accordance with example embodiments of the present disclosure. The example technique 200 shown in FIG. 2 is for illustration only. One or more of the components illustrated in FIG. 2 may be implemented in specialized circuitry configured to perform the noted functions or one or more of the components may be implemented by one or more processors executing instructions to perform the noted functions. Other embodiments of communication mode selection algorithms could be used without departing from the scope of this disclosure.

For comprehensive memory construction, a multi-sensor approach to environment capture may be utilized. In the example technique 200 of FIG. 2, a vision system 201 and an audio system 202 as primary sensing modalities to perceive a user’s surrounding environment. Specifically, the vision system 201 may perform video capture and video streaming and provide robust object recognition capabilities, while the audio system 202 may contribute valuable semantic information, thereby enriching the captured environmental context.

Power consumption may present a critical design consideration, particularly for wearable applications contemplated within this disclosure. The vision capture and video streaming subsystems may be significant contributors to overall power drain in the considered prototype. To mitigate power consumption in the vision capture subsystem, the technique 200 may utilize a keyframe detection method that selectively activates a vision sensor (e.g., a camera) only upon the occurrence of significant events. The vision system 201 may be triggered by auxiliary sensors, such as an Inertial Measurement Unit (IMU), or by a learning-based event detection algorithm. The system architecture may be designed to be sensor-agnostic, allowing for integration with a variety of triggering technologies.

To minimize power consumed by video streaming, the frame rate transmitted to the edge device or cloud for visual processing may be reduced. To ensure data integrity at a reduced frame rate, a synchronization system 203 may be utilized to continuously align the image and audio streams, guaranteeing temporal coherence. This synchronization methodology may be adaptable to incorporate data from sensors beyond vision and audio. High-power sensors may operate at lower sampling rates than power-efficient sensors, rendering synchronization crucial for validating and correlating user data from disparate sources.

Furthermore, the continuous stream of sensor data may be segmented into clips 204, with the clip duration configurable as a system parameter. For example, key frames (representative frames of a video clip) may be detected to save bandwidth and power. Precise configuration of this parameter may be important to balance the need for capturing sufficient temporal context while avoiding saturation of the VLM with excessively long input sequences. This segmentation may also promote data organization and facilitate raw data visualization as needed for analysis or debugging.

For efficient deployment, particularly on resource-constrained edge devices, the technique 200 may utilize a text-based memory system. This system may employ VLMs 205 and audio transcription models 206 to convert raw video and audio clips into textual representations, specifically video captions 207 and audio transcriptions 208, respectively. To maximize the information density and minimize storage requirements while preserving key information, prompts for the VLM and audio transcription model may be carefully engineered to elicit concise and informative outputs.

For the video captioning, a prompt may be designed to focus on: (i) segment identification that groups frames into segments based on similarity in content, especially the background and the main entities; (ii) detailed description such as the main activities taking place, the environment and surroundings, all visible entities, etc.; (iii) clarity and precision to ensure that descriptions are clear and precise, capturing all notable details; and (iv) chronological order of segments based on timestamps.

For the audio transcription 208, a prompt may be designed to help the model pay attention to some special yet commonly encountered scenarios. For example, the transcription 208 may contain some conversion mistakes, typographical errors, oral language, incomplete sentences and colloquial expressions. Also, there may be a possibility that there is actually no real word in the audio, and the recorded audio may simply represent environmental noise or non-speech sound.

To form the ultimate textual clip, there may be a final step to synchronize the video caption 207 and audio transcription 208. An LLM may be utilized to clean and align the video caption 207 and the audio transcription 208. This task may largely infer the speaker of the audio transcription from the human appeared in the video caption, and merge the two separate yet related text chunks into one episodic chunk 209. There may be some guidelines provided for a successful completion of this task. For instance, if no human is detected in the video caption, it may be assumed that the audio transcription is from the one who is recording the video. This may be important for the considered ego-centric wearables.

In summary, the captioning system may receive raw video and audio clips directly from sensors as input. The output may be a textual summary of the combined video and audio content. This textual summary, referred to herein as an episode, may serve as a fundamental unit for memory expansion and organization.

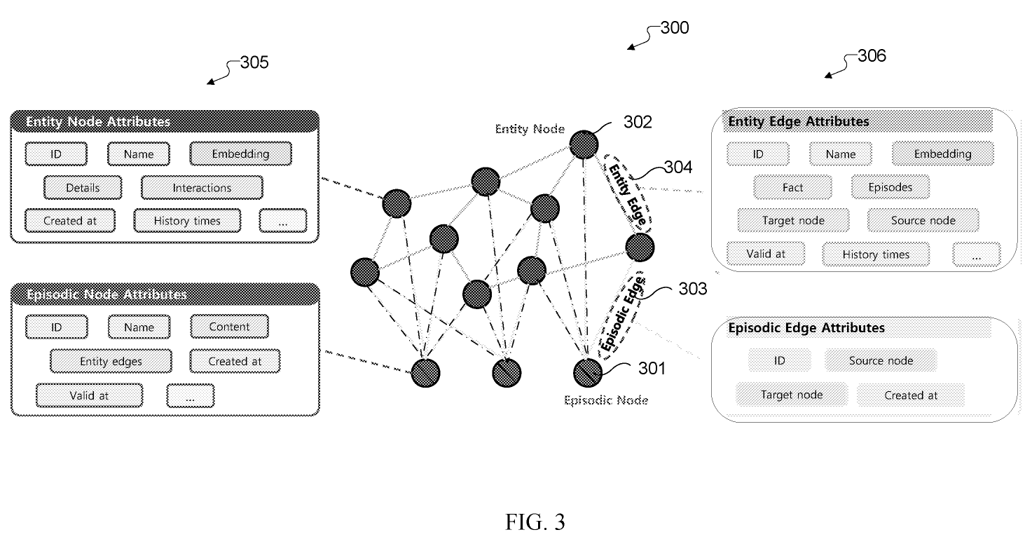

FIG. 3 illustrates an example STKG architecture 300 in accordance with example embodiments of the present disclosure. The example architecture 300 shown in FIG. 3 is for illustration only. One or more of the components illustrated in FIG. 3 may be implemented in specialized circuitry configured to perform the noted functions or one or more of the components may be implemented by one or more processors executing instructions to perform the noted functions. Other embodiments of communication mode selection algorithms could be used without departing from the scope of this disclosure.

An STKG may be utilized as the primary data structure for storing and organizing memory. For example, an STKG may be utilized as a data structure to organize information captured by an XR device (e.g., an AR/VR device) or an HMD device. STKGs may offer inherent advantages for representing dynamic relationships and contextual information. The example architecture 300 in FIG. 3 may be a hierarchical STKG architecture that may include two distinct types of nodes:
Episodic nodes 301: These nodes may store the raw information, specifically the textual descriptions of individual episodes generated by the captioning system.
Entity nodes 302: These nodes may represent distinct objects or entities extracted from the episodic descriptions.
Correspondingly, two types of edges may connect these nodes:
Episodic edges 303: These edges may link episodic nodes to entity nodes, indicating the presence or association of a particular entity within a specific episode. This connection may enable applications such as information back tracing, allowing the system to identify all episodes in which a given entity appeared.
Entity edges 304: These edges may connect entity nodes, representing relationships and associations between different entities. This may capture semantic relationships such as physical proximity, causality, or co-occurrence, etc.

This hierarchical structure may enable efficient querying and reasoning over the stored memory, facilitating advanced use cases such as answering questions utilizing temporal reasoning over extended periods and resolving queries that rely on implicit contextual understanding.

To further advance the capability, node attributes 305 and edge attributes 306 may be fully utilized to store relevant information. For example, not only the name of an entity (e.g., table, cup, etc.) may be stored, but also the details and interactions of an entity may be included in its attributes.

Specifically, “details” may include some descriptions of the entity, e.g., a large table, a green cup, etc., which may help make the entity unique and distinguishable. As in scenes with real-world complexity, there may be many semantically similar objects in the same captured image (for example, in an office setup, there might be a large number of people, desks, cups, etc.). For the memory aid system to work, scene objects may be uniquely identified and properly associated with other objects (e.g., the green mug belongs to person A and red mug belongs to person B). The “interactions” attribute may describe how the scene object interacts with the surrounding environment or other scene objects, i.e., the relationships between different scene objects. This may help bring more semantic meaning to the entity which later facilitates LLMs to make proper inference and reasoning. For example, the extracted node details and node interactions may improve context information (e.g., situation, environment, location, etc.) and be utilized to transform the unstructured media data into structured text-based relational tuples using VLMs and LLMs.

Moreover, to enable event counting, the STKG 300 may utilize an attribute called “history times” which may hold all the historic mentions of a given entity. For example, timestamps as attributes may be added to nodes and edges as they appear in a raw media source. The timestamps may improve the functions of the nodes and edges because they may provide temporal information and be utilized for practical real-world applications such as event counting. This may be significantly different from most STKG designs where they always utilize the most updated timestamp for an entity and therefore, the history information is lost.

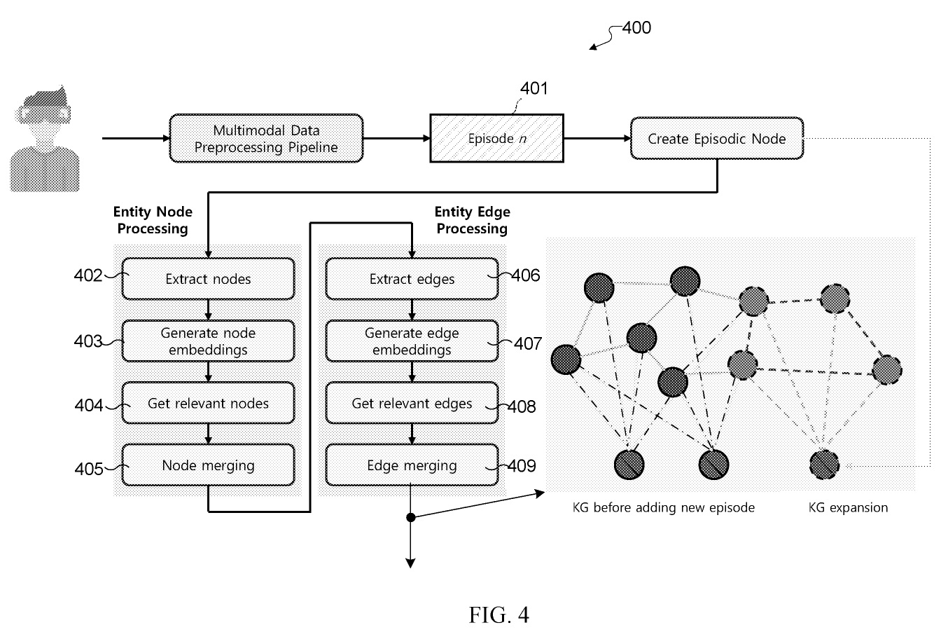

FIG. 4 illustrates an example dynamic STKG update mechanism 400 in accordance with example embodiments of the present disclosure. The example mechanism 400 shown in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of communication mode selection algorithms could be used without departing from the scope of this disclosure.

In light of the continuous influx of new data, the dynamic STKG update mechanism 400 may be utilized to ensure the seamless integration of newly acquired knowledge into the memory system while maintaining control over the STKG’s size and complexity. This incremental STKG construction process, driven by incoming text episodes 401 may constitute one of core aspects of the enhanced memory system in accordance with the present disclosure.

The mechanism 400 may include node extraction operation 402, node embedding operation 403, node similarity search operation 404, node merging operation (also referred to as node merging/deduplication operation) 405, edge extraction operation 406, edge embedding operation 407, edge similarity search operation 408, and edge merging operation (also referred to as edge merging/deduplication operation) 409.

For the node extraction operation 402, an LLM call may be initiated to extract all the semantic nodes from the incoming episode. The LLM may extract relation tuples from unstructured text descriptions. Specifically, the LLM may be prompted to pay more attention to object details and interaction. Object details (e.g., different people) may be important in distinguishing different objects with same semantic meaning. Interactions may define how a particular object is impacting or being impacted by the environment or other objects. This may help extract edges in a later stage.

For the node embedding operation 403, node name and node details may be concatenated. Utilizing names alone to represent a node may not meet the uniqueness of the nodes. By incorporating details into the embedding, important node properties may be contained. This may significantly enhance the search accuracy and efficiency.

For the node merging/deduplication operation 405, it may be important to understand, when a new node is extracted from the incoming episode, whether this node is a completely new object, or it is actually one of the existing objects that have already been captured. This process may be referred to as node-reidentification. This may help control the size of the STKG and, meanwhile, reduce the noise during search. The node merging/deduplication operation 405 may be further decomposed into several sub procedures. First, a similarity search operation 404 may be performed to associate the new node with a set of existing nodes that show a highest similarity (based on their embeddings). Second, an LLM call may be initiated to decide whether this node is completely new or it is one of the existing ones. Third, in case it belongs to one of the existing nodes, the attributes of this existing node may be updated by appending new information brought by the “new node”. Such sub procedure may be performed on all of the newly extracted nodes. At the end of the node merging operation 405, there may be an updated node set that incorporates the new information.

For the edge extraction operation 406, upon finalizing the node update, new edges may also be extracted or updated. For this, optimized context for LLM may be created. Specifically, the following information may be utilized: (i) episode data: this is the new merged text description of synchronized video and audio clips; (ii) all the existing nodes; and (iii) all the existing relationships, where a relationship is represented by node A, node B, edge name (i.e., relationship between node A and B), and edge fact, which is a short description of such relationship (normally being the raw information based on which such relationship is determined).

For the edge embedding operation 407, the newly extracted edges from the episodic data may also be embedded into numerical vectors for ease of subsequent processing. To this end, fact may be utilized as edge embedding.

For the edge merging/deduplication operation 409, relevant edges may be retrieved 408 and edge merging 409 may be performed after new edges have been extracted and embedded. This process may constitute as edge-reidentification. It may serve as a similar role as node merging where new information may be incorporated into the existing STKG while maintaining a concise and clean profile. Note that the node merging operation 405 and the edge merging operation 409 remove the duplicates nodes and edges, thereby reducing graph complexity while preserving node and edge details. For example, without the node merging operation, the STKG may contain a significant number of duplicated nodes that represent the same physical entity. This may take a significant amount of storage space, and when performing graph search, the duplicated information may also appear in the search result, leading to performance degradation.

In summary, the STKG 400 may be continuously updated as new episode data becomes available. The node and edge merging/deduplication algorithm may ensure that the knowledge graph remains concise while retaining the details for effective information retrieval. Further, useful properties may be flexibly added as node or edge attributes.

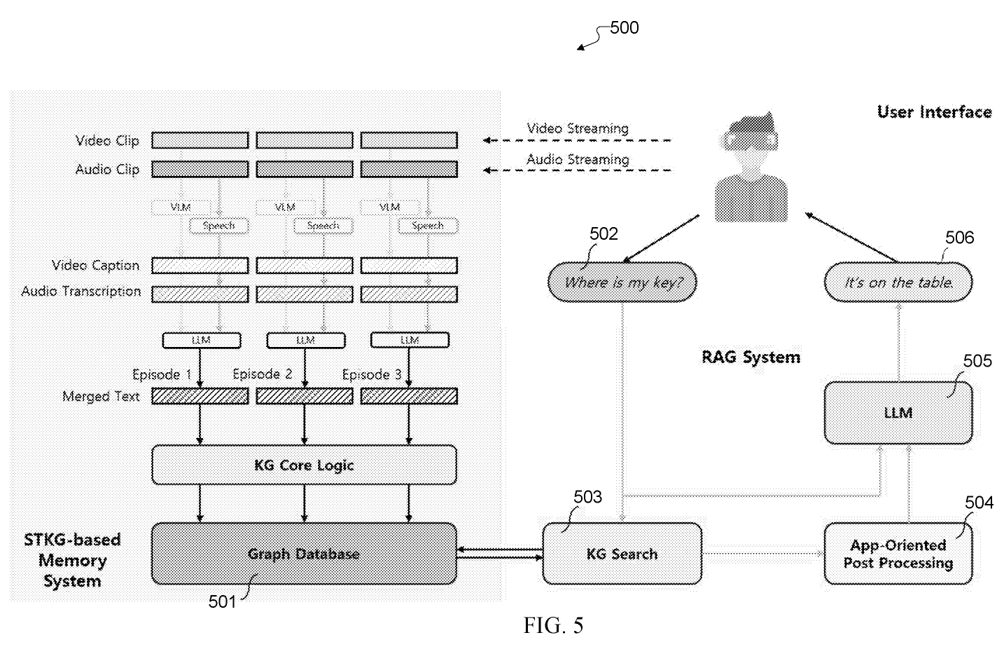

FIG. 5 illustrates an example STKG-based memory system 500 in accordance with example embodiments of the present disclosure. The example system 500 shown in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of communication mode selection algorithms could be used without departing from the scope of this disclosure.

The extracted nodes and edges may be continuously written into a graph database 501. For example, Neo4j® may be utilized as graph database backend. A lightweight graph database management system that may be deployed (at least partially) on edge devices may be utilized in order to reduce retrieval latency by means of proactive content caching. Once the STKG is constructed, the memory system 500 may support question-answering for the past experience that is encoded into the knowledge base. The general flow may be similar to a normal retrieval-augmented generation (RAG) system. First, a query 502 of the user may be embedded into the same embedding space as the knowledge graph. Second, a similarity search 503 may be performed on both nodes and edges of the STKG. Third, the details, interactions, and history times of each retrieved nodes, as well as the episode and history times of the edge, may be parsed to create the context of the query during the app-oriented post processing 504. Finally, both the original query and the retrieved context may be sent to the LLM 505 to generate the response 506 to the user. The specific context formation method may be dependent on tasks in hand. For instance, if a prototype system is primarily focused on an event counting problem, history times attribute of nodes and edges may be important and the context may be prepared in a way that emphasizes more on this regard.

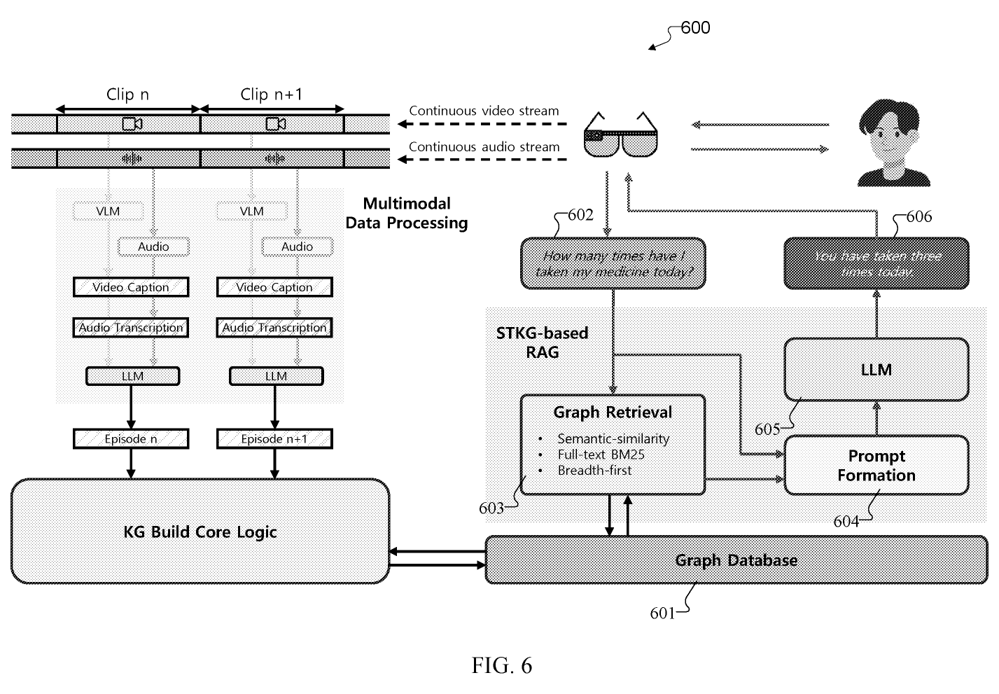

FIG. 6 illustrates an example STKG-based memory system 600 in accordance with example embodiments of the present disclosure. The example system 600 shown in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of communication mode selection algorithms could be used without departing from the scope of this disclosure.

The system 600 may be similar to the STKG-based memory system 500 of FIG. 5, but may perform a prompt formation 604 upon retrieval 603 of relevant node and edge data. The retrieval may be based on semantic-similarity, full-text BM25 (best matching 25) and breadth-first algorithm. The LLM 605 may generate the response 606 based on the prompt.

The system 600 may be a fully optimized processing pipeline that is able to update the memory in real-time.

Note that the example STKG-based memory system of the present disclosure may be utilized in a variety of contexts. It may assist the elderly in their memory recall. As such, the digital memory system may serve as a reliable companion for elderly users and help them manage daily tasks and recall important information, for example:
Medication Management: The system may record each time the user takes their medication, including the dosage and time. If the user forgets whether they have taken their morning pills, the system may provide a detailed log, such as: “You took your medication at 8:15 AM today, including two tablets of X and one tablet of Y.”
Daily Routines: The system may remind users of their daily activities, such as when they last watered their plants or fed their pets, ensuring they maintain a consistent routine.
Location of Personal Items: If an elder misplaces their glasses or wallet, the system may search through its spatial-temporal graph and provide a location-based response, such as: “You last placed your glasses on the living room couch at 3:45 PM yesterday.”

It may also provide business and professional assistance. The system may act as a powerful tool for professionals, helping them manage meetings, partnerships, and projects efficiently, for example:
Meeting Summaries and Discussions: During a business meeting, the system may record the conversation and generates a summary. Later, if a user needs to recall specific details, such as who proposed a particular idea or what was agreed upon, the system may provide: “During your meeting with Partner A on May 10th, you discussed launching a new product in Q4. Partner A suggested focusing on the European market.”
Partner and Client Tracking: The system may maintain a record of all interactions with partners or clients, including dates, locations, and key topics discussed. This may ensure that users may not miss important follow-ups or details.
Project Management: For ongoing projects, the system may track milestones, decisions made, and actions taken, providing users with a comprehensive history to reference during reviews or audits.

The system may act as a personal assistant for daily life and enhance users’ personal lives by retrieving important memories and providing actionable insights, for example:
Retrieving Photos and Memories: If a user wants to find a specific photo from a trip or event, the system may search through its spatial-temporal graph and provide: “The photo you’re looking for was taken during your trip to Paris on June 15th, 2023. It’s located in your ‘Travel Memories’ album.”
Learning from Past Experiences: The system may analyze past actions and provide feedback to help users avoid repeating mistakes. For instance: “Last time you tried baking cookies on July 20th, you forgot to preheat the oven. This time, remember to preheat it to 350°F before placing the dough in.”
Event Planning and Reminders: The system may assist users in planning events by recalling past experiences. For example: “When you hosted a dinner party on December 5th, you served lasagna and garlic bread. Would you like to use the same menu for your upcoming gathering?”

The system may also provide health and wellness monitoring, for example:
Exercise Tracking: The system may record workouts, including duration, intensity, and location. If a user wants to know how often they have exercised in the past month, the system may provide: “You exercised 12 times in April, with an average duration of 45 minutes per session.”
Dietary Habits: By analyzing recorded meals, the system may help users track their calorie intake or identify patterns in their eating habits.

The system may additionally provide travel and navigation assistance, for example:
Trip Planning: The system may recall past travel experiences, such as favorite destinations or routes taken, to assist with future planning. For example: “During your trip to Japan in March 2023, you enjoyed visiting Kyoto’s temples and tried sushi at a restaurant near Shibuya Crossing.”
Lost Item Recovery: If a user loses their luggage or misplaces an item during travel, the system may provide location-based clues from its spatial-temporal graph.

The system may further perform legal and financial record-keeping, for example:
Document Retrieval: The system may store and retrieve important documents, such as contracts or receipts, based on metadata like date, location, or keywords. For instance: “Your lease agreement for the apartment at 123 Main St. was signed on January 15th, 2023.”
Financial Transactions: By analyzing recorded financial activities, the system may help users track spending patterns or locate specific transactions.

The system may also provide education support, for example:
Learning Progress: The system may record study sessions, including topics covered and time spent, helping students track their progress over time. For instance: “You studied calculus for 3 hours on April 10th and focused on integration techniques.”
Exam Preparation: By analyzing past exam results and study habits, the system may provide personalized recommendations for improvement.

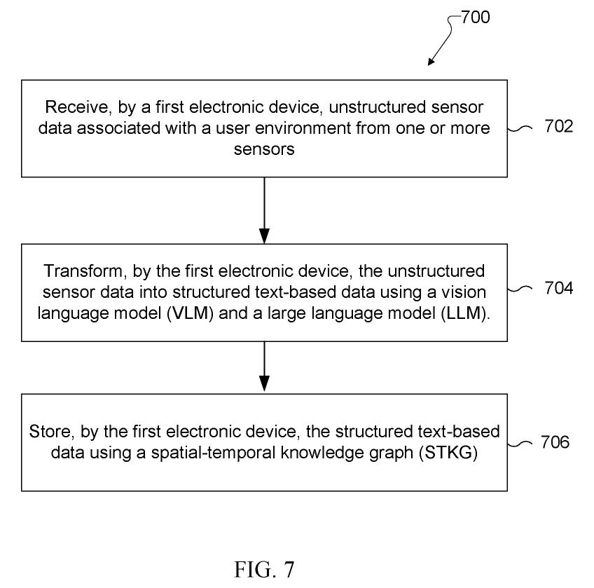

FIG. 7 illustrates a flow chart of an example STKG-based memory enhancement method 700 in accordance with example embodiments of the present disclosure. The embodiment of the communication method in FIG. 7 is for illustration only. Other embodiments of the communication methods may be used without departing from the scope of this disclosure. In the example of FIG. 7, the communication method 700 may be performed by a first electronic device (such as an electronic device 101 of FIG. 1).

In the example of FIG. 7, the method 700 may begin at step 702. At step 702, the first electronic device may receive unstructured sensor data associated with a user environment from one or more sensors. In one embodiment, the unstructured sensor data may be received by selectively activating the one or more sensors based on an event occurrence, and reducing a frame rate transmitted to an edge device for processing.

At step 704, the first electronic device may transform the unstructured sensor data into structured text-based data using a VLM and an LLM. In one embodiment, the unstructured sensor data may be transformed by detecting key frames from clips of the unstructured sensor data, converting the unstructured sensor data into text descriptions using the LLM, the text descriptions including a video caption and an audio transcription, and aligning the video caption and the audio transcription for temporal coherence to generate a final textual clip. In one embodiment, the unstructured sensor data may be transformed by captioning a video clip based on a prompt configured to focus on a segment identification, a description associated with content of the video clip, and a chronological order of identified segments; by transcribing an audio clip based on a prompt configured to identify at least one of a conversion mistake, a typographical error, an oral language, an incomplete sentence, a colloquial expression, and an environment noise; and synchronizing a video caption and an audio transcription into an episode.

At step 706, the first electronic device may store the structured text-based data using a STKG. In one embodiment, the STKG may include an episodic node storing textual descriptions of an episode, an entity node representing objects extracted from the textual descriptions, an episodic edge linking an episodic node to an entity node, and an entity edge connecting entity nodes.

In one embodiment, the first electronic device may update the STKG. The STKG may be updated by extracting, using the LLM, semantic nodes from an incoming episode based on object details and interaction; embedding the semantic nodes by concatenating node names and node details; associating each semantic node with a set of existing nodes of the STKG based on a similarity search; identifying, using the LLM, each semantic node as a first node capturing a new object or a second node capturing a previously captured object by an existing node; updating the set of the existing nodes by at least one of adding the first node or appending new information from the second node to the existing node; extracting edges from the incoming episode based on episode data, the updated node set, node relationships, and edge facts; embedding the extracted edges from the episode data into vectors; and performing edge merging by incorporating new edge information into the STKG.

In one embodiment, the first electronic device may receive a user query, embed the user query into an embedding space of the STKG, perform a similarity search on nodes and edges of the STKG, create a context of the user query based on details, interactions and history times of each node and an episode and history times of each edge (the history times including historical information of corresponding nodes or edges), and generating a response to the user query based on the user query and the context using the LLM.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims. None of the description in this application should be read as implying that any particular element, step, or function is an essential element that must be included in the claim scope. The scope of patented subject matter is defined only by the claims.

What is claimed is:

1. A method comprising:
receiving, by a first electronic device, unstructured sensor data associated with a user environment from one or more sensors;
transforming, by the first electronic device, the unstructured sensor data into structured text-based data using a vision language model (VLM) and a large language model (LLM); and
storing, by the first electronic device, the structured text-based data using a spatial-temporal knowledge graph (STKG).

2. The method of claim 1, wherein transforming the unstructured sensor data comprises:
detecting key frames from clips of the unstructured sensor data;
converting the unstructured sensor data into text descriptions using the LLM, the text descriptions including a video caption and an audio transcription; and
aligning the video caption and the audio transcription for temporal coherence to generate a final textual clip.

3. The method of claim 1, wherein transforming the unstructured sensor data comprises:
captioning a video clip based on a prompt configured to focus on a segment identification, a description associated with content of the video clip, and a chronological order of identified segments;
transcribing an audio clip based on a prompt configured to identify at least one of a conversion mistake, a typographical error, an oral language, an incomplete sentence, a colloquial expression, and an environment noise; and
synchronizing a video caption and an audio transcription into an episode.

4. The method of claim 1, wherein the STKG comprises an episodic node storing textual descriptions of an episode, an entity node representing objects extracted from the textual descriptions, an episodic edge linking an episodic node to an entity node, and an entity edge connecting entity nodes.

5. The method of claim 1, further comprising:
updating, by the first electronic device, the STKG,
wherein updating the STKG comprises:
extracting, using the LLM, semantic nodes from an incoming episode based on object details and interaction;
embedding the semantic nodes by concatenating node names and node details;
associating each semantic node with a set of existing nodes of the STKG based on a similarity search;
identifying, using the LLM, each semantic node as a first node capturing a new object or a second node capturing a previously captured object by an existing node;
updating the set of the existing nodes by at least one of adding the first node or appending new information from the second node to the existing node;
extracting edges from the incoming episode based on episode data, the updated node set, node relationships, and edge facts;
embedding the extracted edges from the episode data into vectors; and
performing edge merging by incorporating new edge information into the STKG.

6. The method of claim 1, wherein receiving the unstructured sensor data comprises:
selectively activating the one or more sensors based on an event occurrence; and
reducing a frame rate transmitted to an edge device for processing.

7. The method of claim 1, further comprising:
receiving, by the first electronic device, a user query;
embedding, by the first electronic device, the user query into an embedding space of the STKG;
performing, by the first electronic device, a similarity search on nodes and edges of the STKG;
creating, by the first electronic device, a context of the user query based on details, interactions and history times of each node and an episode and history times of each edge, the history times including historical information of corresponding nodes or edges; and
generating, by the first electronic device, a response to the user query based on the user query and the context using the LLM.

8. A first electronic device comprising:
memory; and
a processor operably coupled to the memory, the processor configured to:
receive unstructured sensor data associated with a user environment from one or more sensors;
transform the unstructured sensor data into structured text-based data using a vision language model (VLM) and a large language model (LLM); and
store the structured text-based data using a spatial-temporal knowledge graph (STKG).

9. The first electronic device of claim 8, wherein, to transform the unstructured sensor data, the processor is further configured to:
detect key frames from clips of the unstructured sensor data;
convert the unstructured sensor data into text descriptions using the LLM, the text descriptions including a video caption and an audio transcription; and
align the video caption and the audio transcription for temporal coherence to generate a final textual clip.

10. The first electronic device of claim 8, wherein, to transform the unstructured sensor data, the processor is further configured to:
caption a video clip based on a prompt configured to focus on a segment identification, a description associated with content of the video clip, and a chronological order of identified segments;
transcribe an audio clip based on a prompt configured to identify at least one of a conversion mistake, a typographical error, an oral language, an incomplete sentence, a colloquial expression, and an environment noise; and
synchronize a video caption and an audio transcription into an episode.

11. The first electronic device of claim 8, wherein the STKG comprises an episodic node storing textual descriptions of an episode, an entity node representing objects extracted from the textual descriptions, an episodic edge linking an episodic node to an entity node, and an entity edge connecting entity nodes.

12. The first electronic device of claim 8, wherein:
the processor is further configured to update the STKG, and
to update the STKG, the processor is further configured to:
extract, using the LLM, semantic nodes from an incoming episode based on object details and interaction;
embed the semantic nodes by concatenating node names and node details;
associate each semantic node with a set of existing nodes of the STKG based on a similarity search;
identify, using the LLM, each semantic node as a first node capturing a new object or a second node capturing a previously captured object by an existing node;
update the set of the existing nodes by at least one of adding the first node or appending new information from the second node to the existing node;
extract edges from the incoming episode based on episode data, the updated node set, node relationships, and edge facts;
embed the extracted edges from the episode data into vectors; and
perform edge merging by incorporating new edge information into the STKG.

13. The first electronic device of claim 8, wherein to receive the unstructured sensor data, the processor is further configured to:
selectively activate the one or more sensors based on an event occurrence; and
reduce a frame rate transmitted to an edge device for processing.

14. The first electronic device of claim 8, wherein the processor is further configured to:
receive a user query;
embed the user query into an embedding space of the STKG;
perform a similarity search on nodes and edges of the STKG;
create a context of the user query based on details, interactions and history times of each node and an episode and history times of each edge, the history times including historical information of corresponding nodes or edges; and
generate a response to the user query based on the user query and the context using the LLM.

15. A non-transitory computer readable medium embodying a computer program, the computer program comprising program code that, when executed by a processor of a first electronic device, causes the first electronic device to:
receive unstructured sensor data associated with a user environment from one or more sensors;
transform the unstructured sensor data into structured text-based data using a vision language model (VLM) and a large language model (LLM); and
store the structured text-based data using a spatial-temporal knowledge graph (STKG).

16. The non-transitory computer readable medium of claim 15, wherein the program code that, when executed by the processor of the first electronic device, causes the first electronic device to transform the unstructured sensor data comprises program code that, when executed by the processor of the first electronic device, causes the first electronic device to:
detect key frames from clips of the unstructured sensor data;
convert the unstructured sensor data into text descriptions using the LLM, the text descriptions including a video caption and an audio transcription; and
align the video caption and the audio transcription for temporal coherence to generate a final textual clip.

17. The non-transitory computer readable medium of claim 15, wherein the program code that, when executed by the processor of the first electronic device, causes the first electronic device to transform the unstructured sensor data comprises program code that, when executed by the processor of the first electronic device, causes the first electronic device to:
caption a video clip based on a prompt configured to focus on a segment identification, a description associated with content of the video clip, and a chronological order of identified segments;
transcribe an audio clip based on a prompt configured to identify at least one of a conversion mistake, a typographical error, an oral language, an incomplete sentence, a colloquial expression, and an environment noise; and
synchronize a video caption and an audio transcription into an episode.

18. The non-transitory computer readable medium of claim 15, wherein the STKG comprises an episodic node storing textual descriptions of an episode, an entity node representing objects extracted from the textual descriptions, an episodic edge linking an episodic node to an entity node, and an entity edge connecting entity nodes.

19. The non-transitory computer readable medium of claim 15, further comprising program code that, when executed by a processor of a first electronic device, causes the first electronic device to update the STKG, and
wherein the program code that, when executed by the processor of the first electronic device, causes the first electronic device to update the STKG comprises program code that, when executed by the processor of the first electronic device, causes the first electronic device to:
extract, using the LLM, semantic nodes from an incoming episode based on object details and interaction;
embed the semantic nodes by concatenating node names and node details;
associate each semantic node with a set of existing nodes of the STKG based on a similarity search;
identify, using the LLM, each semantic node as a first node capturing a new object or a second node capturing a previously captured object by an existing node;
update the set of the existing nodes by at least one of adding the first node or appending new information from the second node to the existing node;
extract edges from the incoming episode based on episode data, the updated node set, node relationships, and edge facts;
embed the extracted edges from the episode data into vectors; and
perform edge merging by incorporating new edge information into the STKG.

20. The non-transitory computer readable medium of claim 15, further comprising program code that, when executed by a processor of a first electronic device, causes the first electronic device to:
receive a user query;
embed the user query into an embedding space of the STKG;
perform a similarity search on nodes and edges of the STKG;
create a context of the user query based on details, interactions and history times of each node and an episode and history times of each edge, the history times including historical information of corresponding nodes or edges; and
generate a response to the user query based on the user query and the context using the LLM.
